(19) United States
(12) Patent Application Publication
(10) Pub. No.: US 2023/0384793 A1
(43) Pub. Date: Nov. 30, 2023

(54) LEARNING DATA COLLECTION DEVICE AND LEARNING SYSTEM

(71) Applicant: KONICA MINOLTA, INC., Tokyo (JP)

(72) Inventor: Hiroki TAJIMA, Itami-shi (JP)

(73) Assignee: KONICA MINOLTA, INC., Tokyo (JP)

(21) Appl. No.: 18/312,392

(22) Filed: May 4, 2023

(30) Foreign Application Priority Data
May 25, 2022 (JP) 2022-085540

(51) Int. Cl. G05D 1/02

(52) U.S. Cl. CPC G05D 1/0221; G05D 1/0246

(57) ABSTRACT

A collection device of learning data of a learning model for detecting a danger of a moving body, includes a hardware processor that determines whether the moving body is in a specific state related to a danger of the moving body by using an output value of a sensor that detects the specific state, and specifies a part of images of an image group used for the danger detection as a learning image in which a cause of falling into the specific state is estimated to be captured on a basis of a timing at which the moving body is determined to be in the specific state.

The entire disclosure of Japanese patent Application No. 2022-085540, filed on May 25, 2022, is incorporated herein by reference in its entirety.

### BACKGROUND

### Technological Field

The present disclosure relates to a technology for recognizing an object from a captured image, and more particularly relates to a technology for recognizing an object that may be a danger in traveling of a moving body.

### Description of the Related Art

A technology for recognizing an object from a captured image using a learning model such as a neural network is demanded in various fields. For example, in order to safely drive an autonomous vehicle or the like, a technology for recognizing an object (dangerous object) that may collide with the vehicle has been proposed (see, for example, JP 2021-176077 A).

In a learning model that recognizes a dangerous object, learning of the learning model is generally performed using an image including an object defined as a danger by a human in advance. However, there is a gap between an object to be recognized as a danger (an object that may actually cause an accident) and the object defined as a danger by a human, and it is difficult to learn all objects to be recognized as a danger.

### SUMMARY

The present disclosure has been made in view of the above problems, and an object thereof is to provide a collection device that collects learning data for recognizing an object to be recognized as a danger, and a learning system that performs learning of a learning model using the learning data collected by the collection device.

To achieve the abovementioned object, according to an aspect of the present invention, a collection device of learning data of a learning model for detecting a danger of a moving body reflecting one aspect of the present invention comprises: a hardware processor that determines whether the moving body is in a specific state related to a danger of the moving body by using an output value of a sensor that detects the specific state, and specifies a part of images of an image group used for the danger detection as a learning image in which a cause of falling into the specific state is estimated to be captured on a basis of a timing at which the moving body is determined to be in the specific state.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 illustrates a configuration of a learning system according to a first embodiment;

FIG. 2 is a block diagram illustrating a configuration of a personal mobility of the first embodiment;

FIG. 3 is a block diagram illustrating a configuration of a server device of the first embodiment;

FIG. 4 is a perspective view for describing arrangement positions of sensors of the first embodiment;

FIG. 5 is a diagram illustrating an example of annotation data according to the first embodiment;

FIG. 6 is a flowchart illustrating an operation at a time of collecting learning data in the personal mobility of the first embodiment;

FIG. 7 is a flowchart illustrating an operation at a time of collecting learning data in the server device of the first embodiment;

FIG. 8 is a flowchart illustrating an operation at a time of learning of a learning model in the server device of the first embodiment;

FIG. 9 is a block diagram illustrating a configuration of a typical neural network;

FIG. 10 is a schematic diagram illustrating one neuron of the neural network;

FIG. 11 is a diagram schematically illustrating a propagation model of data at a time of preliminary learning (training) in the neural network; and

FIG. 12 is a diagram schematically illustrating a propagation model of data at a time of practical inference in the neural network.

### DETAILED DESCRIPTION OF EMBODIMENTS

Hereinafter, one or more embodiments of the present invention will be described with reference to the drawings. However, the scope of the invention is not limited to the disclosed embodiments.

### 1 First Embodiment

1.1 Learning System 1 of Learning Model Related to Dangerous Object Recognition

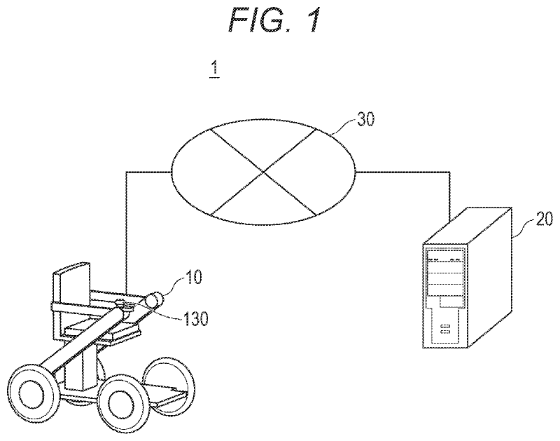

A learning system 1 of a first embodiment will be described with reference to FIG. 1.

The learning system 1 includes a personal mobility 10, a server device 20, and a network 30.

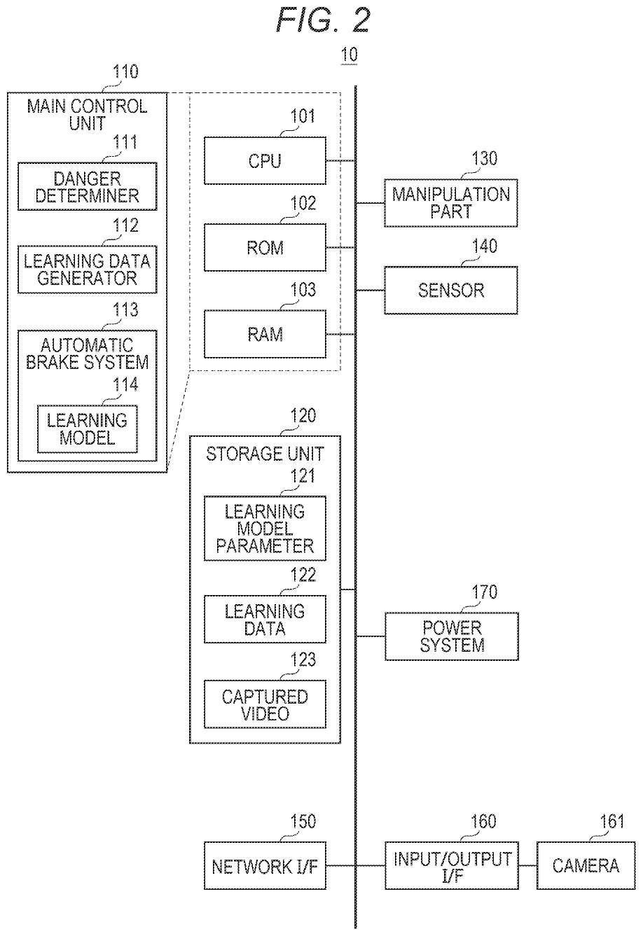

The personal mobility 10 is, for example, a moving body such as an electric wheelchair. The personal mobility 10 includes, for example, a power system 170 (see FIG. 2) such as an electric motor and a manipulation part 130 such as a joystick, in which a traveling direction, a speed, and so on can be controlled by driving the power system 170 according to operation of the manipulation part 130.

The personal mobility 10 is connected to the server device 20 via, for example, a wireless network 30.

The personal mobility 10 includes one or more cameras 161 (see FIG. 2), and captures a video in one or more directions including a traveling direction of the personal mobility 10.

The personal mobility 10 transmits a part of the captured video of the camera 161 to the server device 20 as learning data of a learning model for performing dangerous object recognition.

The server device 20 is a computer that performs learning of a learning model for performing dangerous object recognition. The server device 20 performs learning (additional learning) of the learning model using the learning data received from the personal mobility 10. The server device 20 transmits the learning model after the learning to the personal mobility 10.

The personal mobility 10 includes an automatic brake system 113 (see FIG. 2) that performs dangerous object recognition on the captured video of the camera 161 using the received learning model and automatically performs brake control when a dangerous object is recognized.

1.2 Personal Mobility 10

As illustrated in FIG. 2, the personal mobility 10 includes a central processing unit (CPU) 101, a read only memory (ROM) 102, a random access memory (RAM) 103, a storage unit 120, the manipulation part 130, a sensor 140, a network interface 150, and an input/output interface 160 connected to a bus.

(CPU 101, ROM 102, and RAM 103)

The RAM 103 includes a semiconductor memory, and provides a work area when the CPU 101 executes a program.

The ROM 102 includes a semiconductor memory. The ROM 102 stores a control program that is a computer program for causing the CPU 101 to execute each process, and the like.

The CPU 101 is a processor that operates according to the control program stored in the ROM 102.

By the CPU 101 operating according to the control program stored in the ROM 102 using the RAM 103 as a work area, the CPU 101, the ROM 102, and the RAM 103 constitute a main control unit 110.

(Main Control Unit 110)

The main control unit 110 integrally controls the entire personal mobility 10.

Further, the main control unit 110 functions as a danger determiner 111, a learning data generator 112, and the automatic brake system 113.

(Danger Determiner 111)

The danger determiner 111 determines whether or not the personal mobility 10 is in a specific state.

In the present disclosure, the specific state indicates a state in which the personal mobility 10 has fallen into an accident such as a collision or a fall, a state in which an accident such as a collision or a fall has been avoided immediately before, and a state equivalent thereto.

The danger determiner 111 determines whether or not it is in the specific state using a detection result of the sensor 140. In addition, the danger determiner 111 may determine whether or not it is in the specific state using the detection result of the sensor 140 and a driving operation reception result of the manipulation part 130.

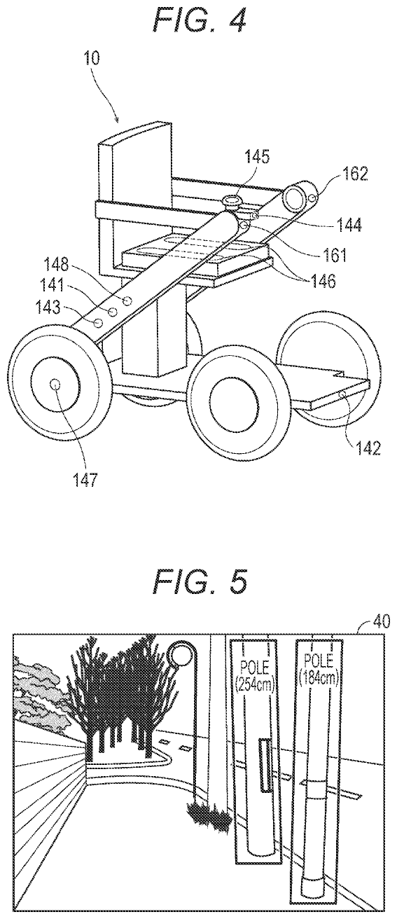

As the sensor 140, for example, an acceleration sensor 141, a collision sensor 142, a gyro sensor 143, a microphone 144, a pressure sensor 145, a pressure sensor 146, a speed sensor 147, a vibration sensor 148, and the like illustrated in FIG. 4 can be used.

The acceleration sensor 141 detects acceleration during motion of the personal mobility 10.

The collision sensor 142 is a pressure sensor that measures pressure applied to a predetermined part of the personal mobility 10. The collision sensor 142 is disposed, for example, at a portion that first comes into contact with a wall when the personal mobility 10 travels toward the wall, or the like.

The gyro sensor 143 detects an angular velocity during motion of the personal mobility 10.

The microphone 144 mainly detects a voice uttered by an occupant of the personal mobility 10. The microphone 144 may be disposed at a position close to the occupant's mouth, and may have directivity so as to detect a sound in the direction of the occupant's mouth.

The pressure sensor 145 is a pressure sensor disposed on a grip part (joystick portion) of the manipulation part 130, and detects pressure applied to the grip part of the manipulation part 130.

The pressure sensor 146 is a pressure sensor disposed in a seat part of the personal mobility 10, and detects pressure applied to the seat part of the personal mobility 10. The pressure sensor 146 is provided on both left and right sides of the seat, and can detect on which side of the seat the center of gravity of the occupant is biased from an output ratio thereof.

The speed sensor 147 is a sensor that detects the rotation speed of a drive wheel of the personal mobility 10, and detects the speed of the personal mobility 10 from the rotation speed of the drive wheel.

The vibration sensor 148 detects vibration of the personal mobility 10 by measuring “displacement” or “acceleration” of the personal mobility 10.

[Specific State]

The danger determiner 111 determines that the personal mobility 10 is in the specific state for the following nine patterns.

(Pattern 1: Rapid Deceleration is Detected)

When sudden deceleration of the personal mobility 10 is detected, the danger determiner 111 determines that the personal mobility has fallen into the specific state. The danger determiner 111 may monitor an output of the acceleration sensor 141 and detect sudden deceleration of the personal mobility 10 when deceleration (a negative value of acceleration) becomes equal to or more than a predetermined threshold.

(Pattern 2: Detection of Collision)

When the collision of the personal mobility 10 is detected, the danger determiner 111 determines that the personal mobility has fallen into the specific state. The danger determiner 111 may monitor an output of the collision sensor 142 and detect a collision of the personal mobility 10 when the output becomes equal to or more than a predetermined value.

(Pattern 3: Sudden Direction Change is Detected)

When sudden steering wheel movement (sudden direction change) of the personal mobility 10 is detected, the danger determiner 111 determines that the personal mobility has fallen into the specific state. The danger determiner 111 may monitor an output of the gyro sensor 143 and detect the sudden steering of the personal mobility 10 when the output is equal to or more than a predetermined threshold.

(Pattern 4: Detection of Voice Indicating Crisis)

When the occupant of the personal mobility 10 utters a specific keyword, the danger determiner 111 determines that the occupant has fallen into the specific state. The specific keyword may be “wow”, “dangerous”, or the like. The danger determiner 111 may include a voice recognizer (not illustrated) that recognizes a specific keyword, and may detect that the occupant of the personal mobility 10 has uttered the specific keyword by inputting a voice signal output from the microphone 144 to the voice recognizer.

As the speech recognizer, a known speech recognition technology can be used. For example, it is possible to recognize a keyword by converting a voice signal from the microphone 144 into text data using a service that converts a voice into text data, such as the Google Cloud Speech to Text API or Amazon Transcribe, and comparing the converted text data with text data indicating keywords stored in the storage unit 120 in advance.

(Pattern 5: Detection of Sudden Increase in Grip Force to Manipulation Part 130)

The danger determiner 111 determines that the personal mobility has fallen into the specific state when a sudden increase in the grip force of the personal mobility 10 with respect to the manipulation part 130 is detected. The danger determiner 111 may monitor an output of the pressure sensor 145 and detect a sudden increase in the grip force of the personal mobility 10 with respect to the manipulation part 130 when the output is equal to or more than a predetermined threshold.

(Pattern 6: Detection of Throwing Out of Occupant)

The danger determiner 111 determines that the occupant has fallen into the specific state when throwing out of the occupant of the personal mobility 10 is detected. The danger determiner 111 may monitor an output of the pressure sensor 146 and detect the throwing of the occupant of the personal mobility 10 when a change in the output, more specifically, a change rate of the pressure decrease becomes equal to or more than a predetermined threshold.

(Pattern 7: Detecting Stuck State)

The danger determiner 111 determines that the personal mobility 10 has fallen into the specific state when detecting a state in which the personal mobility cannot move (stuck state). The danger determiner 111 may compare a manipulation status by the manipulation part 130 with an operation status of the personal mobility 10 based on the outputs of the acceleration sensor 141, the gyro sensor 143, the speed sensor 147, and the like, and detect the stuck state of the personal mobility 10 when the manipulation status and the operation status do not match.

(Pattern 8: Inclination or Falling is Detected)

When an inclination or falling of the personal mobility 10 is detected, the danger determiner 111 determines that the personal mobility has fallen into the specific state. The danger determiner 111 may monitor the output of the pressure sensor 146, calculate the center of gravity of the occupant from the output ratio of the two sensors, and detect the inclination or falling of the personal mobility 10 when extreme movement of the center-of-gravity to the left or right is detected (when the center-of-gravity position is separated from the seat center by a predetermined threshold or more).

(Pattern 9: Detect Dangerous Road Surface Conditions)

The danger determiner 111 determines that the vehicle has fallen into the specific state when traveling in dangerous road surface conditions is detected. The danger determiner 111 may monitor an output of the vibration sensor 148 and detect traveling in the dangerous road surface conditions when the output of the sensor is equal to or more than a predetermined threshold.

(Learning Data Generator 112)

When the danger determiner 111 determines that the personal mobility is in the specific state, the learning data generator 112 generates the learning data by sequentially performing learning image specification processing, distance measurement processing, dangerous object specification processing, and annotation data generation processing.

(Learning Image Specification Processing)

In the learning image specification processing, the learning data generator 112 first acquires the time when the danger determiner 111 determines that it is in the specific state.

Next, the learning data generator 112 calculates a time that is a predetermined time before (for example, 1 to 5 seconds before) the acquired time.

Then, the learning data generator 112 acquires the captured image at the calculated time among the captured images of the camera 161 stored in the storage unit 120.

Finally, the learning data generator 112 specifies the acquired captured image as a learning image.

Here, in the present embodiment, the learning data generator 112 calculates each time of three seconds before, two seconds before, and one second before the time at which the danger determiner 111 determines that it is in the specific state, and specifies a captured image at each of the times as the learning data.

It is conceivable that, in an image captured by the camera 161 immediately before the personal mobility 10 falls into the specific state, an object that has caused the personal mobility 10 to fall into the specific state is captured. Accordingly, by specifying the captured image immediately before the time when the danger determiner 111 determines that it is in the specific state as the learning data, an object that has caused the personal mobility 10 is estimated to be in the specific state is included in the learning image. Therefore, the learning data generator 112 specifies an image in which the object that has caused the personal mobility 10 to be in the specific state is estimated to be included as the learning image.

Further, in the present embodiment, a plurality of images is specified at intervals of a predetermined time (here, each second) from three seconds ago, two seconds ago, and one second ago. Thus, it is possible to specify learning images of various variations while the situation changes from moment to moment. Note that, if the time interval is too narrow, the difference between the images decreases, and thus it is desirable to set a time interval (for example, one second) at which a change between the images is considered to appear.

(Distance Measurement Processing)

The learning data generator 112 performs distance measurement from the host device for each pixel (each coordinate) of the learning image specified by the learning image specification processing.

A known technology can be used for distance measurement. For example, distance measurement by LiDAR may be performed using the output of the LiDAR sensor 162 (see FIG. 4). In addition, distance measurement by ultrasonic waves may be performed using an output of an ultrasonic sensor (not illustrated). Further, the distance measurement may be performed using the VSLAM technology. Furthermore, the distance measurement may be performed using a neural network that performs distance measurement such as Keras or DenseDepth.

(Dangerous Object Specification Processing)

The learning data generator 112 specifies a “dangerous object” included in the learning image specified by the learning image specification processing on the basis of a distance of each pixel calculated by the distance measurement processing. For example, the learning data generator 112 determines a region of the learning image as a background region and an object region from a difference between the distance of each pixel calculated for the learning image and the distance of each pixel calculated for an image captured on a plane without any obstacle. Then, an object within a predetermined distance (for example, within 4 m) in the region determined as an object is specified as the “dangerous object”.

In addition, when the danger determiner 111 determines that the specific state is reached by detection of traveling in dangerous road surface conditions, or the like, the learning data generator 112 may specify a region within a predetermined distance (for example, within 4 m) in the region determined as a background as a “dangerous road surface”.

(Annotation Data Generation Processing)

The learning data generator 112 creates annotation data of the region specified as the “dangerous object” or the “dangerous road surface”.

The annotation data is data indicating coordinates of the region specified as the “dangerous object” or the “dangerous road surface”.

The annotation data may include information of distance information to the indicated “dangerous object” or “dangerous road surface”.

The annotation data may include information identifying whether the indicated region indicates the “dangerous object” or the “dangerous road surface”.

When the indicated region is the “dangerous object”, the annotation data may include information indicating the type of the object. The type of the object can be detected using, for example, a neural network technology such as YOLO that performs object recognition.

FIG. 5 is an example of generated annotation data. The annotation data 401 and the annotation data 402 are generated for the learning image 40.

The learning data generator 112 stores the learning image specified by the learning image specification processing and the annotation data generated by the annotation data generation processing in the storage unit 120 as the learning data.

(Automatic Brake System 113)

The automatic brake system 113 performs dangerous object detection by a learning model 114 and brake control when a dangerous object is detected. The learning model 114 is a neural network.

(Dangerous Object Detection by Learning Model)

The automatic brake system 113 reads a learning model parameter 121 from the storage unit 120 and configures the learning model 114 for dangerous object detection.

The automatic brake system 113 reads a captured video 123 from the storage unit 120, and inputs each frame image of the captured video to the learning model 114.

The learning model 114 performs dangerous object detection on the frame image and outputs a detection result as to whether or not a dangerous object is detected.

(Brake Control when Dangerous Object is Detected)

When the detection result of the learning model 114 indicates that the dangerous object is detected, the automatic brake system 113 transmits an instruction to perform brake control to the power system 170 and causes the personal mobility 10 to stop.

(Storage Unit 120)

The storage unit 120 includes, for example, a hard disk drive. The storage unit 120 may include a semiconductor memory such as a solid state drive.

The storage unit 120 stores the parameter of the learning model received from the server device 20 via the communication interface 150 as the learning model parameter 121.

The personal mobility 10 periodically receives the parameter of the learning model from the server device 20 and updates the learning model parameter 121 of the storage unit 120.

The storage unit 120 stores learning data 122 generated by the learning data generator 112.

The storage unit 120 stores the captured video 123 received from the camera 161 via the input/output interface 160.

(Manipulation Part 130)

The manipulation part 130 is a device for steering the personal mobility 10, receives an instruction such as forward movement, backward movement, direction change, acceleration/deceleration, or the like, and transmits the instruction to the power system 170.

The steering may be performed by a joystick or may be performed by a steering wheel.

(Communication Interface 150)

The communication interface 150 is connected to the server device 20 via the network 30. The communication interface 150 is a communication interface compatible with a wireless communication standard such as “LTE” or “5G”.

(Input/Output Interface 160)

The input/output interface 160 is connected to the camera 161 via a dedicated cable.

The input/output interface 160 receives the captured video from the camera 161, and writes the received captured video in the storage unit 120.

(Camera 161)

The camera 161 is fixed at a predetermined position of the personal mobility 10 and is installed in a predetermined direction. The camera 161 may be installed on the front surface of the personal mobility 10 and assume the traveling direction as an image-capturing range. In addition, the camera 161 may also be installed on a side surface and a rear surface and assume the entire circumference of the personal mobility 10 as an image-capturing range.

(Power System 170)

The power system 170 includes an electric motor that drives the drive wheel of the personal mobility 10, a battery for driving the electric motor, and the like.

1.3 Server Device 20

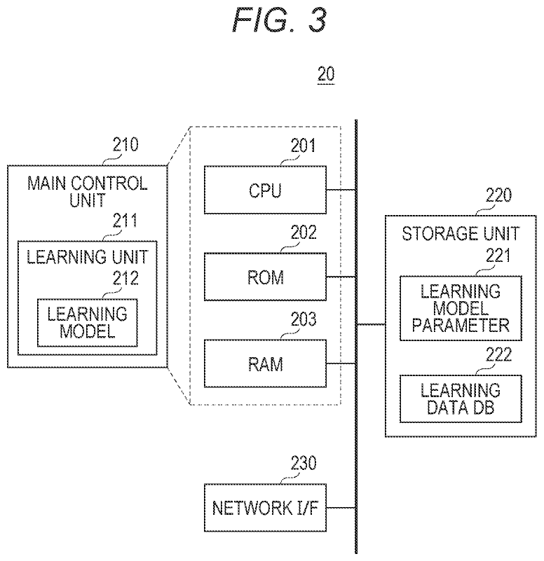

As illustrated in FIG. 3, the server device 20 includes a CPU 201, a ROM 202, a RAM 203, a storage unit 220, and a network interface 230 connected to a bus.

(CPU 201, ROM 202, and RAM 203)

The RAM 203 includes a semiconductor memory, and provides a work area when the CPU 201 executes a program.

The ROM 202 includes a semiconductor memory. The ROM 202 stores a control program that is a computer program for causing the CPU 201 to execute each process, and the like.

The CPU 201 is a processor that operates according to the control program stored in the ROM 202.

By the CPU 201 operating according to the control program stored in the ROM 202 using the RAM 203 as a work area, the CPU 201, the ROM 202, and the RAM 203 constitute a main control unit 210.

(Main Control Unit 210)

The main control unit 210 integrally controls the entire server device 20.

Further, the main control unit 210 functions as a learning unit 211.

(Learning Unit 211)

The learning unit 211 reads a learning model parameter 221 from the storage unit 220 and configures a learning model 212.

The learning unit 211 reads learning data registered in a learning data DB 222 of the storage unit 220 and performs additional learning of the learning model 212.

The learning unit 211 updates the learning model parameter 221 of the storage unit 220 with a parameter of the learning model 212 after the additional learning.

The learning unit 211 periodically (for example, once a month) performs additional learning of the learning model 212 and updates the learning model parameter 221.

(Storage Unit 220)

The storage unit 220 includes, for example, a hard disk drive. The storage unit 220 may include a semiconductor memory such as a solid state drive.

The storage unit 220 stores the parameter of the learning model after the learning by the learning unit 211 as the learning model parameter 221.

The storage unit 220 registers the learning data received from the personal mobility 10 in the learning data DB 222 via the communication interface 230.

(Communication Interface 230)

The communication interface 230 is connected to the personal mobility 10 via the network 30.

1.4 Operation

(Operation of Personal Mobility 10 During Collection of Learning Data)

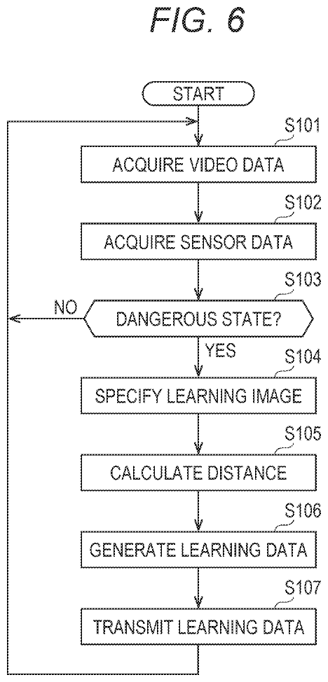

The operation of the personal mobility 10 at the time of collecting learning data will be described with reference to a flowchart illustrated in FIG. 6.

The main control unit 110 controls the input/output interface 160 to acquire the captured video 123 from the camera 161 and write the captured video 123 in the storage unit 120 (step S101).

The main control unit 110 (danger determiner 111) acquires an output (sensor data) from the sensor 140 (step S102), and determines whether or not it is in the specific state related to a danger of the personal mobility 10 on the basis of the sensor data (step S103).

When it is determined that it is not the specific state (step S103: No), the main control unit 110 returns to step S101 and continues the processing.

When it is determined that the personal mobility is in the specific state (step S103: Yes), the main control unit 110 (learning data generator 112) specifies a time at which a cause of the personal mobility 10 to fall into the specific state is estimated to be image-captured on the basis of the time at which the personal mobility is determined to be in the specific state. The main control unit 110 (learning data generator 112) acquires the frame image at the specified time in the captured video 123 from the storage unit 120, and specifies the frame image as the learning image (step S104).

The main control unit 110 (learning data generator 112) performs distance measurement for each pixel of the image specified as the learning image (step S105).

The main control unit 110 (learning data generator 112) specifies a “dangerous object” or a “dangerous road surface” on the basis of the measured distance, and generates annotation data of the specified “dangerous object” or “dangerous road surface”. The main control unit 110 (learning data generator 112) generates the learning image and the annotation data as the learning data 122 and stores the learning image and the annotation data in the storage unit (step S106).

The main control unit 110 reads the learning data from the storage unit 120 and transmits the learning data 122 to the server device 20 via the communication interface 150 (step S107).

After transmitting the learning data 122, the main control unit 110 returns to step S101 and continues the processing.

(Operation of Server Device 20 at Time of Collecting Learning Data)

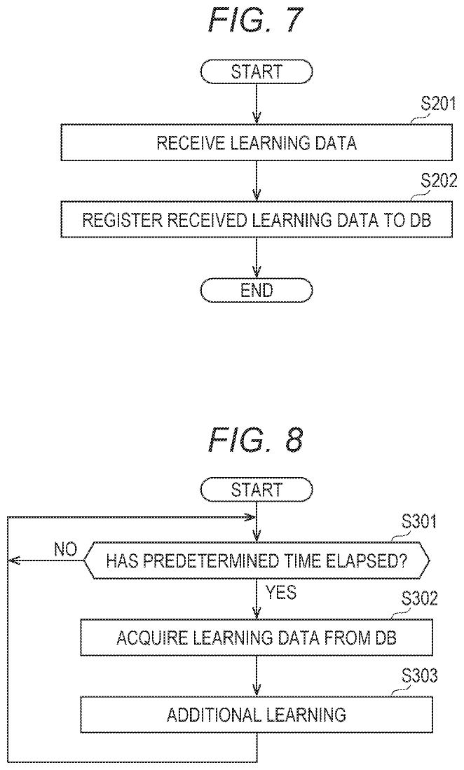

The operation of the server device 20 at the time of collecting learning data will be described with reference to a flowchart of FIG. 7.

The main control unit 210 receives the learning data from the personal mobility 10 via the communication interface 230 (step S201).

The main control unit 210 registers the received learning data in the learning data DB 222 of the storage unit 220 (step 202).

(Operation During Learning of Learning Model of Server Device 20)

The operation of the server device 20 at the time of learning the learning model will be described with reference to a flowchart of FIG. 8.

The main control unit 210 (learning unit 211) determines whether or not it is a learning timing of a learning model to be periodically executed. That is, the main control unit 210 (learning unit 211) determines whether or not a predetermined time has elapsed from the time of the previous learning (step S301).

When it is the learning timing of the learning model (step S301: Yes), the main control unit 210 (learning unit 211) proceeds to step S302. When it is not the learning timing of the learning model (step S301: No), the main control unit 210 (learning unit 211) returns to step S301.

The main control unit 210 (learning unit 211) acquires learning data from the learning data DB 222 (step S302).

The main control unit 210 (learning unit 211) performs additional learning of the learning model using the acquired learning data, and stores the parameter of the learning model after the learning as the learning model parameter 221 in the storage unit 220 (step S303).

1.5 Summary

According to the personal mobility 10, when the personal mobility 10 actually falls into a dangerous state, since an image in which the cause is image-captured is automatically collected as learning data, there is a possibility that learning data about a dangerous object that is unexpected by a human can be collected. Then, when a situation is encountered in which it is possible to fall into the learned dangerous state is likely to occur again, determination of danger can be made in advance, and the danger can be avoided by the automatic brake system 113, for example. By accumulating learning in this manner, falling into a dangerous state is reduced, and safe traveling of the personal mobility 10 can be achieved.

Note that, in the above embodiment, one personal mobility 10 communicates with one server device 20, but a plurality of personal mobility 10 may communicate with one server device 20.

In addition, in the above embodiment, the learning method of the learning model of dangerous object detection mounted on the personal mobility 10 has been described, but the learning method may be used for learning by the learning model of dangerous object detection mounted on a moving body capable of autonomous movement, such as a work robot operated in a factory or a guide robot operated in a shop.

2 Supplement (Regarding Typical Neural Network)

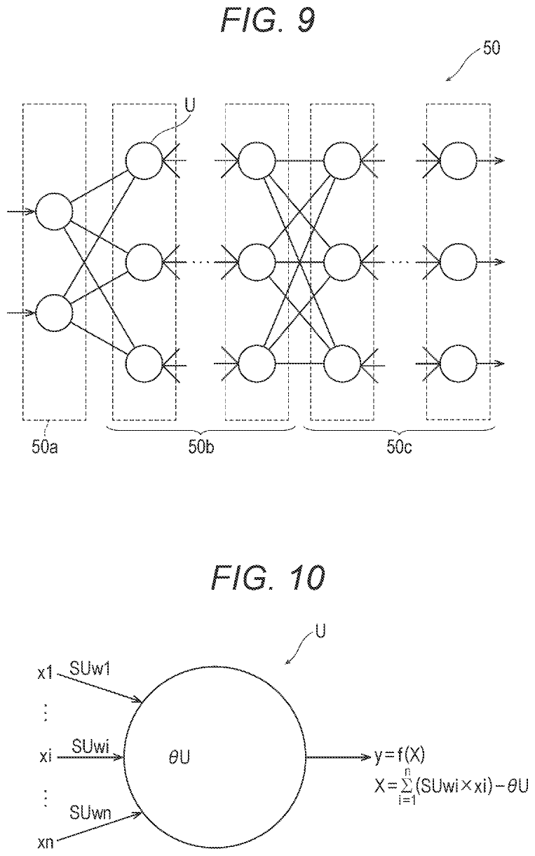

As an example of a typical neural network, the neural network 50 illustrated in FIG. 9 will be described.

(1) Structure of Neural Network 50

As illustrated in this drawing, the neural network 50 is a hierarchical neural network including an input layer 50a, a feature extraction layer 50b, and a recognition layer 50c.

Here, the neural network is an information processing system that mimics a human neural network. In the neural network 50, an engineering neuron model corresponding to a nerve cell is referred to as a neuron U herein. The input layer 50a, the feature extraction layer 50b, and the recognition layer 50c each include a plurality of neurons U.

The input layer 50a is usually composed of one layer. Each neuron U of the input layer 50a receives, for example, a pixel value of each pixel constituting one image. The received image value is directly output from each neuron U of the input layer 50a to the feature extraction layer 50b.

The feature extraction layer 50b extracts features from data (all pixel values constituting one image) received from the input layer 50a, and outputs the features to the recognition layer 50c. The feature extraction layer 50b extracts, for example, a region in which an object that has a possibility of becoming a dangerous object such as a utility pole appears from the received image by calculation in each neuron U.

The recognition layer 50c performs identification using the features extracted by the feature extraction layer 50b. The recognition layer 50c identifies, for example, whether the object is a dangerous object from the region of the object extracted in the feature extraction layer 50b by a calculation in each neuron U.

As the neuron U, a multiple-input single-output element is usually used as illustrated in FIG. 10. The signal is transmitted only in one direction, and the input signal xi (i=1, 2, . . . , n) is multiplied by a certain neuron weighting value (SUwi) and input to the neuron U. This neuron weighting value represents the strength of connection between the neuron U and the neuron U arranged in a hierarchical manner. The neuron weighting values can be varied by learning. From the neuron U, a value X obtained by subtracting the neuron threshold θU from the sum of input values (SUwi×xi) multiplied by a neuron weighting value SUwi is output after being deformed by a response function f(X). That is, an output value y of the neuron U is expressed by the following mathematical expression.

y=f(X)
where
X=Σ(SUwi×xi)−θU. Note that, as the response function, for example, a sigmoid function can be used.

Each neuron U of the input layer 50a usually does not have a sigmoid characteristic or a neuron threshold. Therefore, the input value appears in the output as it is. On the other hand, each neuron U in the final layer (output layer) of the recognition layer 50c outputs an identification result in the recognition layer 50c.

As a learning algorithm of the neural network 50, for example, an error back propagation method (back propagation) is used in which a neuron weighting value and the like of the recognition layer 50c and a neuron weighting value and the like of the feature extraction layer 50b are sequentially changed using a steepest descent method so that a square error between a value (data) indicating a correct answer and an output value (data) from the recognition layer 50c is minimized.

(2) Training Process

A training process in the neural network 50 will be described.

The training process is a process of performing preliminary learning of the neural network 50. In the training process, preliminary learning or additional learning of the neural network 50 is performed using learning image data with a correct answer (with annotation data) obtained in advance.

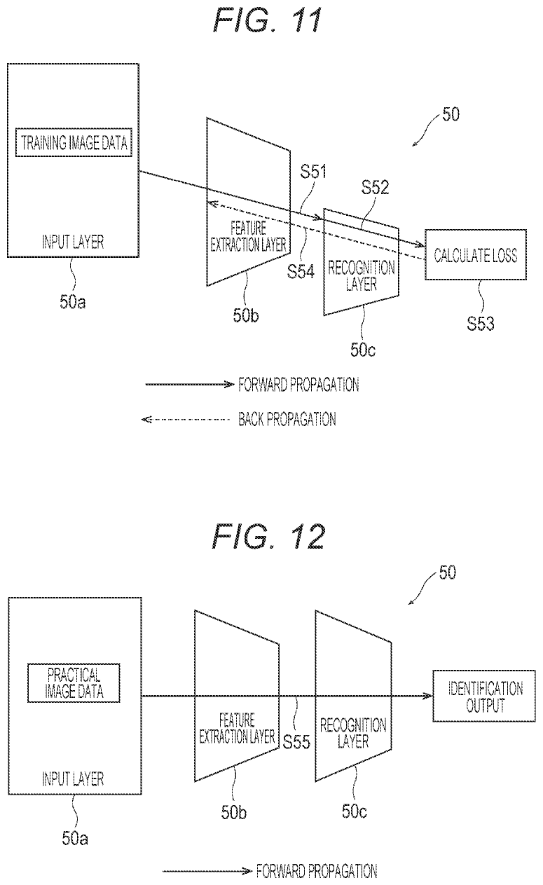

FIG. 11 schematically illustrates a propagation model of data at a time of preliminary learning or additional learning.

The image data is input to the input layer 50a of the neural network 50 for each image, and is output from the input layer 50a to the feature extraction layer 50b. In each neuron U of the feature extraction layer 50b, an operation with a neuron weighting value is performed on the input data. By this calculation, in the feature extraction layer 50b, a feature (for example, a region of the object) is extracted from the input data, and data indicating the extracted feature is output to the recognition layer 50c (step S51).

In each neuron U of the recognition layer 50c, calculation with a neuron weighting value for the input data is performed (step S52). Thus, identification (for example, identification of the dangerous object) based on the above features is performed. Data indicating an identification result is output from the recognition layer 50c.

The output value (data) of the recognition layer 50c is compared with a value indicating a correct answer, and these errors (losses) are calculated (step S53). The neuron weighting value and the like of the recognition layer 50c and the neuron weighting value and the like of the feature extraction layer 50b are sequentially changed so as to reduce this error (back propagation) (step S54). Thus, the recognition layer 50c and the feature extraction layer 50b are learned.

(3) Practical Recognition Process

A practical recognition process in the neural network 50 will be described.

FIG. 12 illustrates a propagation model of data in a case where recognition (for example, recognition of a dangerous object) is actually performed using data obtained on site as an input using the neural network 50 learned by the above training process.

In the practical recognition process in the neural network 50, feature extraction and recognition are performed using the learned feature extraction layer 50b and the learned recognition layer 50c (step S55).

It is useful as a technology for performing learning of a learning model of dangerous object detection mounted on a moving body such as a personal mobility or a robot that performs autonomous movement.

With a collection device according to an embodiment of the present disclosure, when a moving body actually falls into a specific state related to a danger, an image estimated to include a cause thereof is collected as the learning data, so that an object that cannot be expected by a human can also be learned as an object to be recognized as a danger.

Although embodiments of the present invention have been described and illustrated in detail, the disclosed embodiments are made for purposes of illustration and example only and not limitation. The scope of the present invention should be interpreted by terms of the appended claims.

What is claimed is:

1. A collection device of learning data of a learning model for detecting a danger of a moving body, the collection device comprising
a hardware processor that
determines whether the moving body is in a specific state related to a danger of the moving body by using an output value of a sensor that detects the specific state, and
specifies a part of images of an image group used for the danger detection as a learning image in which a cause of falling into the specific state is estimated to be captured on a basis of a timing at which the moving body is determined to be in the specific state.

2. The collection device according to claim 1, wherein
the sensor is an acceleration sensor, and
the hardware processor determines that the moving body has fallen into the specific state when sudden deceleration of the moving body is detected on a basis of the acceleration sensor.

3. The collection device according to claim 1, wherein
the sensor is a collision sensor, and
the hardware processor determines that the moving body has fallen into the specific state when a collision of the moving body is detected on a basis of the collision sensor.

4. The collection device according to claim 1, wherein
the sensor is a gyro sensor, and
the hardware processor determines that the moving body has fallen into the specific state when a sudden direction change of the moving body is detected on a basis of the gyro sensor.

5. The collection device according to claim 1, wherein
the sensor is a microphone, and
the hardware processor determines that the moving body has fallen into the specific state when a voice indicating danger of the moving body is detected on a basis of the microphone.

6. The collection device according to claim 1, wherein
the sensor is a pressure sensor disposed on a grip part of a manipulation part for steering the moving body, and
the hardware processor determines that the moving body has fallen into the specific state when a sudden increase in pressure on the grip part is detected on a basis of the pressure sensor.

7. The collection device according to claim 1, wherein
the sensor is a pressure sensor disposed in a seat part of the moving body, and
the hardware processor determines that the moving body has fallen into the specific state when a sudden pressure decrease with respect to the seat part is detected on a basis of the pressure sensor.

8. The collection device according to claim 1, wherein
the sensor is an acceleration sensor, and
the hardware processor acquires a manipulation status of an occupant with respect to a manipulation part for steering the moving body, detects whether or not the moving body is in a stuck state on a basis of the acquired manipulation status and the acceleration sensor, and determines that the moving body is in the specific state when it is detected that the moving body is in the stuck state.

9. The collection device according to claim 1, wherein
the sensor is a pressure sensor that detects a center-of-gravity movement of an occupant of the moving body disposed in a seat part of the moving body, and
the hardware processor determines that the moving body has fallen into the specific state when extreme movement of a center-of-gravity of an occupant of the moving body is detected on a basis of the pressure sensor.

10. The collection device according to claim 1, wherein
the sensor is a vibration sensor, and
the hardware processor determines that the moving body has fallen into the specific state when vibration equal to or more than a predetermined threshold is detected on a basis of the vibration sensor.

11. The collection device according to claim 1, wherein
the hardware processor
calculates a distance to each object included in the learning image,
creates annotation data for an object within a predetermined distance, and
specifies the learning image and the annotation data as learning data.

12. A learning system, comprising:
the collection device according to claim 1; and
a server device capable of communicating with the collection device,
wherein
the server device performs learning of a learning model for detecting a danger of a moving body using the learning data collected by the collection device.

13. The learning system according to claim 12, wherein
the server device performs additional learning of the learning device periodically at a predetermined interval.
